(19) United States
(12) Patent Application Publication
(10) Pub. No.: US 2022/0367984 A1
(43) Pub. Date: Nov. 17, 2022

(54) BATTERY PACK

(71) Applicant: DENSO CORPORATION, Kariya-city (JP)

(72) Inventors: Tatsuhiro NUMATA, Kariya-city (JP); Shingo KAWAHARA, Kariya-city (JP); Kousuke AOKI, Kariya-city (JP); Takahiro JYO, Kariya-city (JP)

(73) Assignee: DENSO CORPORATION, Kariya-city (JP)

(21) Appl. No.: 17/875,560

(22) Filed: Jul. 28, 2022

Related U.S. Application Data
(63) Continuation of application No. PCT/JP2021/001286, filed on Jan. 15, 2021.

(30) Foreign Application Priority Data
Jan. 28, 2020 (JP) 2020-011994

(51) Int. Cl. H01M 50/528; H01Q 1/24

(52) U.S. Cl. CPC H01M 50/528; H01Q 1/24

(57) ABSTRACT

A battery pack includes: a plurality of assembled batteries disposed in a housing; respective acquisition devices that acquire battery information from the assembled battery corresponding thereto; and a monitor that wirelessly communicates with the respective acquisition devices. The monitor includes a main antenna, and the respective acquisition devices include respective sub-antennas. The respective assembled batteries include respective projections formed thereon, the respective projections including respective conductive connectors configured to electrically connect the battery cells to each other. Hereinafter, the direction in which the respective projections project s defined as a projection direction. The respective sub-antennas are disposed. in the housing, at least a part of the respective sub-antennas being positioned farther in the projection direction than a projection-direction end of the respective conductive connectors is. A direct wave emitted from the main antenna reaches the respective sub-antennas and is thus received without being blocked by the respective conductive connectors.

### CROSS-REFERENCE TO RELATED APPLICATION

The present application is a. continuation application of International Application No. PCT/JP2021/001286, filed on Jan. 15, 2021, which claims priority to Japanese Patent Application No. 2020-011994, filed on Jan. 28, 2020. The contents of these applications are incorporated herein by reference in their entirety.

### BACKGROUND

### Technical Field

The present disclosure relates to a battery pack including a plurality of assembled batteries.

### Background Art

Some battery packs are configured as follows, A battery pack includes a housing made from a metal, and a plurality of assembled batteries, a plurality of acquisition devices, and a monitor disposed in the housing. The acquisition devices are disposed for each of the assembled, batteries, and each of the acquisition devices acquires battery information from the assembled battery corresponding thereto. The monitor wirelessly communicates with the acquisition devices and thus acquires the battery information.

The monitor and the acquisition devices each have an antenna for wireless communication. The radio waves emitted from the antennas are reflected on the inner surfaces of the housing made from a metal, and many reflected waves are thereby generated. Therefore, a plurality of radio waves are sometimes superimposed on a receiver antenna. Radio wave interference by the superimposition sometimes causes communication disturbance, leading to a wireless communication failure or generation of communication blackout.

The magnitude of the communication disturbance caused by the radio wave interference changes with the communication frequency. Therefore, when a communication failure or communication blackout occurs at a certain communication frequency, wireless communication is implemented by changing the communication frequency.

### SUMMARY

In the present disclosure, provided is a battery pack as the following.

The battery pack includes: a plurality of assembled batteries disposed in a housing; respective acquisition devices that acquire battery information from the assembled battery corresponding thereto; and a monitor that wirelessly communicates with the respective acquisition devices. The monitor includes a main antenna, and the respective acquisition devices include respective sub-antennas. The respective assembled batteries include respective projections formed. thereon, the respective projections including respective conductive connectors configured to electrically connect the battery cells to each other. Hereinafter, the direction in which the respective projections project is defined as a projection direction. The respective sub-antennas are disposed in the housing, at least a part of the respective sub-antennas being positioned farther in the projection direction than a projection-direction end of the respective conductive connectors is.

A direct wave emitted from the main antenna reaches the respective sub-antennas and is thus received without being blocked by the respective conductive connectors.

### BRIEF DESCRIPTION OF THE DRAWINGS

The object described above and other objects, features, and advantages of the present disclosure are further clarified by the following detailed description with reference to the accompanying drawings. The drawings include as follows:

FIG. 1 is a perspective view of a battery pack according to a first embodiment;

FIG. 2 is a plan view of the battery pack;

FIG. 3A and FIG. 3B show front sectional views of the battery pack;

FIG. 4A and FIG. 4B show front sectional views illustrating wireless communication in a comparative example and the present embodiment;

FIG. 5 is a front sectional view of a battery pack according to a second embodiment; and.

FIG. 6 is a front sectional view of a battery pack according to a third embodiment.

### DETAILED DESCRIPTION OF THE PREFERRED EMBODIMENTS

PTL 1 below is a document representing the above technique.

[PTL 1] WO2014/103008 A

In the technique described above, changing the communication frequency enables establishment of wireless communication, The technique, however, does not suppress the generation of the communication failure and communication blackout themselves. Therefore, situations can occur in which due to frequent communication failures or communication blackout, the communication frequency is required to be changed accordingly. Such frequent communication failures and communication blackout decreases the frequency of data update. Therefore, such a communication system is not suitable for devices, such as a battery pack, which emphasizes the real-time performance.

The securement of communication reliability, for example, by solving such a problem is particularly difficult when a projection including a conductive connector for electrically connecting battery cells to each other is formed on the antenna side of each of the assembled batteries. The inventor of the present disclosure has focused on this difficulty. Due to space problems or the like, the gap between the inner surfaces of the housing and the conductive connector is likely to be small. In the configuration described above, the antenna of each of the acquisition de vices is therefore likely to be hidden behind the conductive connector with respect to the antenna of the monitor. In such a case, since the conductor has an action of shielding radio waves, the conductive connector shields a. direct wave from each of the antennas of the monitor and the acquisition device to the antenna of the other, Therefore, each of the antennas of the monitor and the acquisition device receives from the antenna of the other only a reflected wave having a lower propagation intensity than the propagation intensity of the direct wave. Further, in the gap between the inner surfaces of the housing and the conductive connector that is likely to be small as described above, the radio waves are likely to be diffusely reflected. Therefore, each of the antennas of the monitor and the acquisition device receives from the antenna of the other only a reflected wave such as a diffusely reflected radio wave, thus making it difficult to secure communication reliability as described above.

The present disclosure has been made in view of the circumstances described above, and a main object of the present disclosure is to secure communication reliability when a projection including a conductive connector for electrically connecting battery cells to each other is formed on the antenna side of each of assembled batteries.

A battery pack according to the present disclosure includes: a housing; a plurality of assembled batteries that are disposed in the housing and each of which includes a plurality of battery cells; respective acquisition devices configured to be disposed for each of the assembled batteries and that acquire from the assembled battery corresponding thereto battery information including voltage information of each of the battery cells; and a monitor configured to acquire the battery information through wireless communication with the respective acquisition devices.

The monitor includes a main antenna for the wireless communication. The respective acquisition devices include respective sub-antennas for the wireless communication. The respective assembled batteries include respective projections formed thereon, the respective projections including respective conductive connectors configured to electrically connect the battery cells to each other and be made from a conductor.

Hereinafter, a direction in which the respective projections project is defined as a projection direction. The respective sub-antennas are disposed in the housing, at least a part of the respective sub-antennas being positioned farther in the projection direction than a projection-direction end of the respective conductive connectors is. A direct wave that is a radio wave emitted from the main antenna and is not reflected reaches the respective sub-antennas and is thus received without being blocked by the respective conductive connectors, and a direct wave that is a radio wave emitted from the respective sub-antenna and is not reflected reaches the main antenna and is thus received without being blocked by the respective conductive connectors.

in the present disclosure, the sub-antenna is disposed in a region farther in the projection direction than the projection-direction end of the respective conductive connectors is in the housing despite the fact that the region is likely to be small due to the space problem or the like. This disposition realizes a structure in which a direct wave from the main antenna reaches each sub-antenna without being blocked by the conductive connector, and each sub-antenna can receive from the main antenna a. direct wave having a higher propagation intensity than the propagation intensity of reflected waves. The disposition also realizes a structure in which a direct wave from each sub-antenna reaches the main antenna without being blocked by the conductive connector, and the main antenna can receive from each sub-antenna a direct wave having a higher propagation intensity than the propagation intensity of reflected waves. The configuration described above enables the securement of communication reliability, in comparison with the cases in which each of the antennas can receive only a reflected wave from the other antenna.

Next, embodiments of the present disclosure are described with reference to the drawings. The present disclosure, however, is not limited to the embodiments and can be implemented with appropriate modifications, without departing from the spirit of the present disclosure.

### First Embodiment

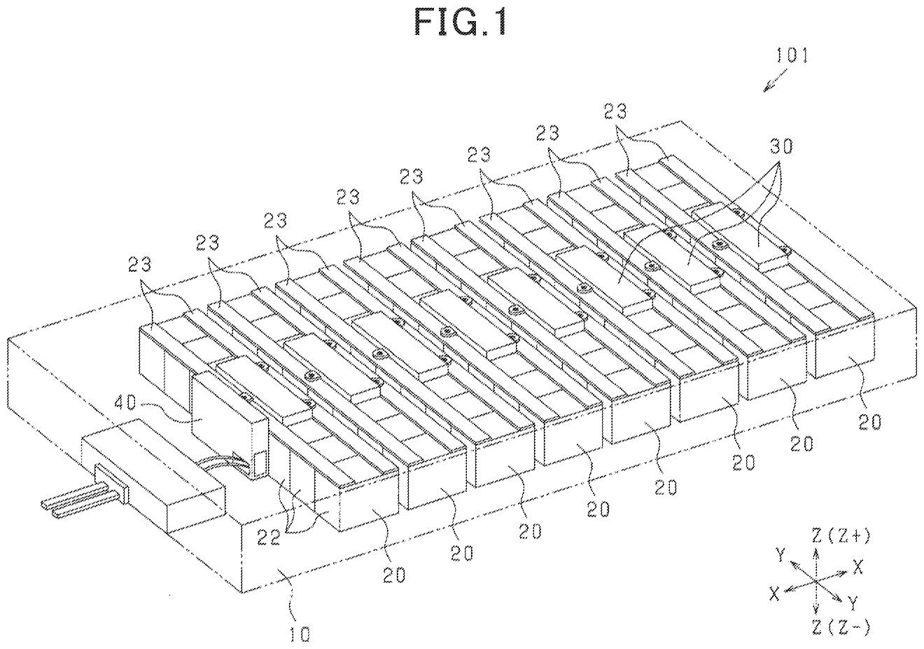

FIG. 1 is a perspective view of a battery pack 101 according to a first embodiment. The battery pack 101 is mounted to a vehicle or the like. The battery pack 101 includes a housing 10 made from a metal, a plurality of assembled batteries 20, a plurality of acquisition devices 30, and a monitor 40, the plurality of assembled batteries 20, the plurality of acquisition devices 30, and the monitor 40 being disposed in the housing. Each of the acquisition devices 30 and the monitor 40 constitute a battery monitoring system that monitors each of the assembled batteries 20.

Hereinafter, the prescribed three directions perpendicular to each other in the drawings are referred to as a “transverse direction X”, a “longitudinal direction Y”, and a “vertical direction Z”. The battery pack 101, however, can be disposed in any direction, for example, by changing the “vertical direction Z” referred to below to the transverse or longitudinal direction, or by changing the “transverse direction X” referred to below to the longitudinal direction.

The plurality of assembled batteries 20 are disposed in parallel in the transverse direction X. Each of the assembled batteries 20 includes a plurality of battery cells 22 arranged in the longitudinal direction Y. On a left end and a right end of an upper surface of each assembled battery 20, a ridge-shaped projection 23 is formed that projects upward (Z+) from the upper surface of the assembled battery 20 and extends in the longitudinal direction Y. Specifically, the projection 23 is a ridge extending from an upper surface of a front-end battery cell 22 to an upper surface of a rear-end battery cell 22.

The acquisition devices 30 are disposed for each of the assembled batteries 20. Each of the acquisition devices 30 is disposed between the left and right projections 23 of the assembled battery 20 corresponding thereto. The acquisition device 30 acquires from the assembled battery 20 corresponding thereto battery information that is information on the assembled battery 20. The battery information includes, for example, voltage information and temperature information of each of the plurality of battery cells 22 included in the assembled battery 20, and information on current flowing in the assembled battery 20.

In the present embodiment, the monitor 40 is attached to a left-side surface of a left-end assembled battery 20. The monitor 40 wirelessly communicates with each of the acquisition devices 30. The monitor 40, for example, transmits to the acquisition device 30 an acquisition command for acquiring the battery information, receives the battery information from each of the acquisition devices 30, and transmits to the acquisition device 30 an equalization command for equalizing the voltage of each of the battery cells 22.

The housing 10 is formed of a conductor such as a metal. Therefore, the whole of the housing 10 constitutes a shielding part that reflects radio waves.

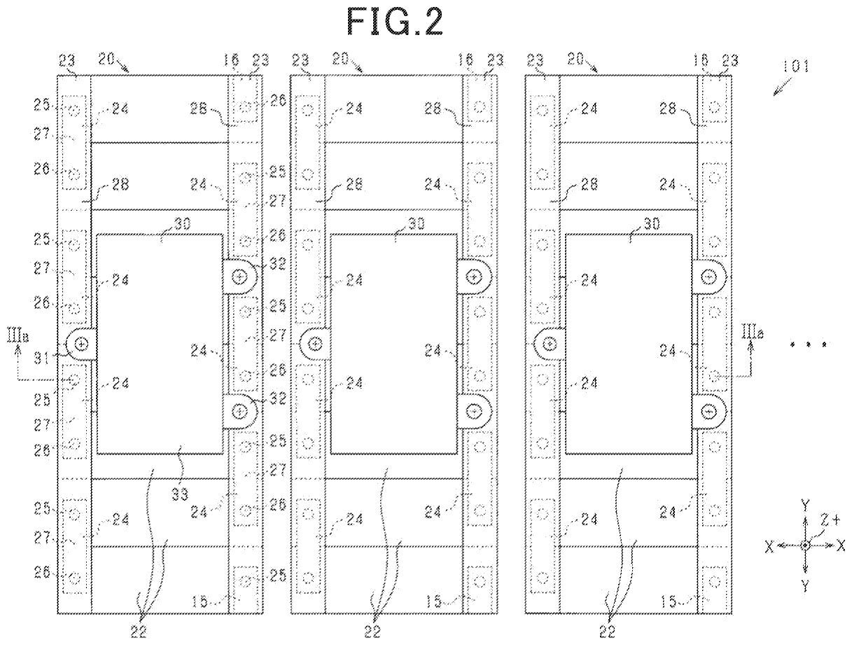

FIG. 2 is a plan view of the battery pack 101. Each of the projection 23 includes a projection base 28 made from a non-conductor, and a conductive connector that electrically connects battery cells 22 to each other and is made from a conductor. The conductive connector 24 includes electrode terminals 25, 26 of each battery cell 22, and a bus bar 27. The bus bar 27 electrically connects the corresponding electrode terminal 25 and the corresponding electrode terminal 26 of battery cells 22 adjacent to each other in the longitudinal direction Y. The projection base 28 is made from a resin or the like and is disposed in such a form as to cover the conductive connector 24.

More specifically, in each of the assembled batteries 20, each of the battery cells 22 includes a positive electrode terminal 25 and a negative electrode terminal 26 as the electrode terminals 25, 26. For example, the front-end battery cell 22 is disposed to have the negative electrode terminal 26 on its left side and the positive electrode terminal 25 on its right side. In contrast to the front-end battery cell 22, a second front-end battery cell 22 is disposed to have the positive electrode terminal 25 on its left side and the negative electrode terminal 26 on its right side, Similarly to the front-end battery cell 22, a third front-end battery cell 22 is disposed to have the negative electrode terminal 26 on its left side and the positive electrode terminal 25 on its right side.

As described above, each of the battery cells 22 arranged in the longitudinal direction Y is disposed to have the positive electrode terminal 25 and negative electrode terminal 26 thereof positioned transversely (X) opposite to the positions of the positive electrode terminal and negative electrode terminal of a battery cell 22 in front thereof. Each of the battery cells 22 except the rear-end battery cell 22 has the negative electrode terminal 26 thereof electrically connected via the bus bar 27 to the positive electrode terminal 25 of a battery cell 22 therebehind. The plurality of battery cells 22 are thereby electrically connected in series. The positive electrode terminal 25 of the front-end battery cell 22 is connected to prescribed positive electrode wiring 15, and the negative electrode terminal 26 of the rear-end battery cell 22 is connected to prescribed negative electrode wiring 16,

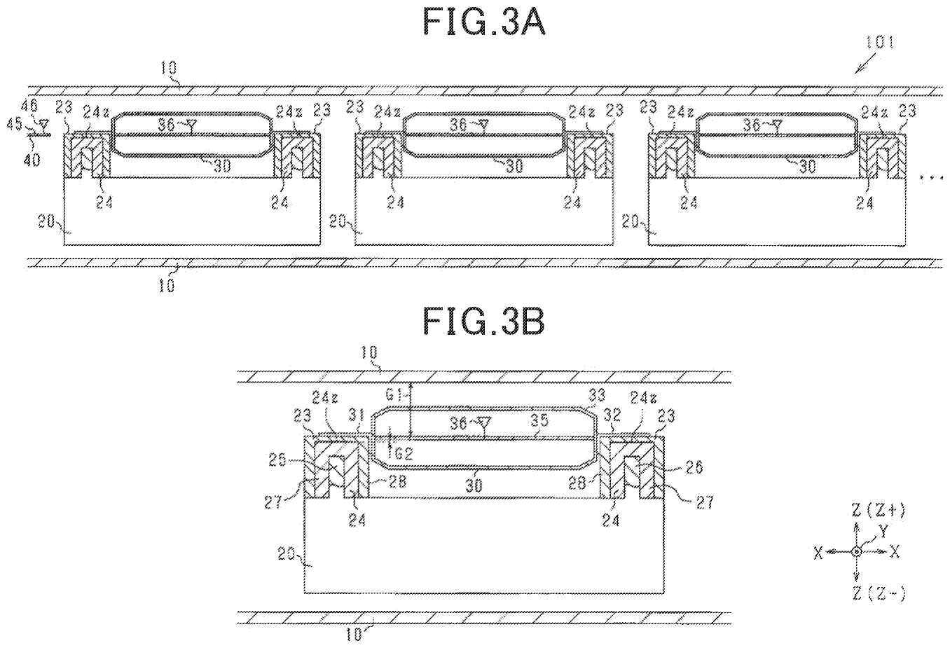

FIG. 3A is a sectional view along a line IIIa-IIIa in FIG. 2 FIG. 3B is an enlarged view of a left-end assembled battery 20 and the periphery thereof in FIG. 3A. The bus bar 27 is disposed in such a form as to cover from above the negative electrode terminal 26 and the positive electrode terminal 25 which the bus bar electrically connects each other. Therefore, an upper end of the bus bar 27 constitutes an upper end 24z of the conductive connector 24. The projection base 28 is disposed in such a form as to cover from above the bus bar 27.

Each of the acquisition devices 30 includes a case 33 made from a non-conductor such as a resin, and a substrate 35 disposed in the case 33. A sub-antenna 36 for wireless communication with the monitor 40 is disposed on the substrate 35. On a left-side surface of the case 33, a left attachment 31 that projects leftward is provided. On a right-side surface of the case 33, a right attachment 32 that projects rightward is provided.

The left attachment 31 is fixed with a screw or the like to the left-side projection 23 of each of the assembled batteries 20. The right attachment 32 is fixed with a screw or the like to the right-side projection 23 of the assembled battery 20. The case 33 is thereby attached to the left and right projections 23 of the assembled battery 20 corresponding thereto in such a form as to be disposed across the left and right projections 23. Therefore, the transverse (X) position of the sub-antenna 36 is between the left and right projections 23 of the assembled battery 20 corresponding to the sub-antenna 36. The longitudinal (Y) positions of sub-antennas 36 may be the same or may be longitudinally (Y) shifted from each other.

A lower portion of the case 33 is positioned between the projections 23 and lower (Z−) than the upper end 24z of the conductive connector 24. On the other hand, an upper portion of the case 33 and the substrate 35 are positioned higher (Z+) than the upper end 24z of the conductive connector 24.

Hereinafter, the vertical (Z) gap between an upper surface of the substrate 35 and a ceiling surface of the housing 10 is referred to as a “first gap G1”, and the vertical (Z) gap between the upper end 24z of the conductive connector 24 and a lower surface of the substrate 35 is referred to as a second gap G2. In the present embodiment, the upper gap, i.e., the first gap G1 is larger than the lower gap, i.e., the second gap G2. The sub-antenna 36 is disposed on the upper surface of the substrate 35 in such a form as to project upward (Z+) from the upper surface of the substrate 35. Therefore, each of the acquisition devices 30 includes the sub-antenna 36 higher than the upper end 24z of the conductive connector 24.

The monitor 40 also includes a substrate 45 at the same height as the height of the substrate 35 of each of the acquisition devices 30. A main antenna 46 for wireless communication with the acquisition devices 30 is disposed on an upper surface of the substrate 45 in such a form as to project upward (Z+) from the upper surface of the substrate 45. Therefore, the monitor 40 includes the main antenna 46 higher (Z+) than the upper end 24z of the conductive connector 24.

According to the present embodiment, the following effects can be obtained. Hereinafter, a radio wave never reflected after being emitted from the antenna 36, 46 is referred to as a “direct wave”, and a radio wave reflected even once after being emitted from the antenna 36, 46 is referred to as a “reflected wave”.

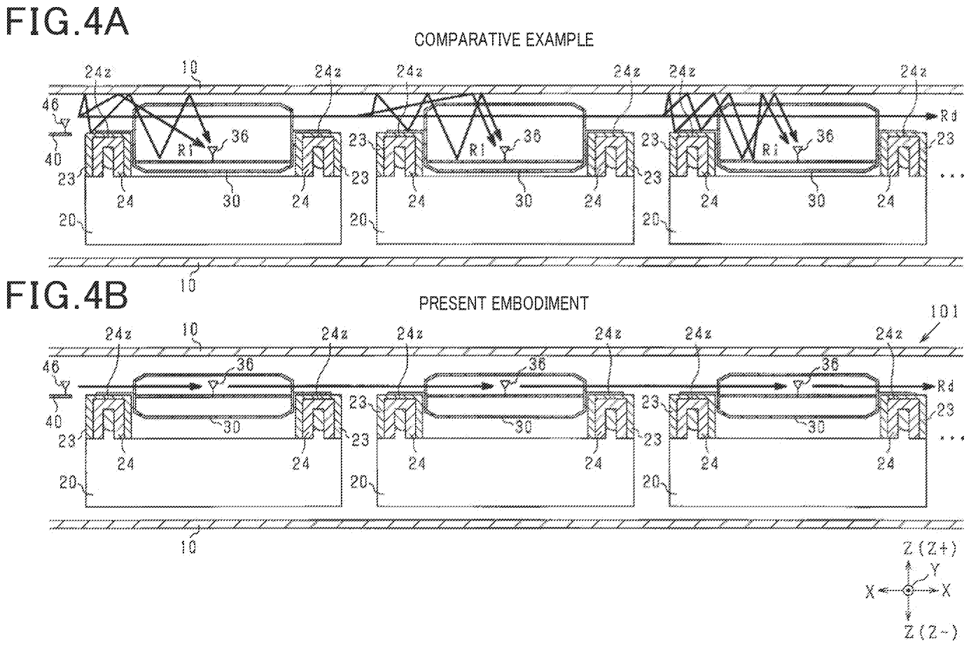

FIG. 4A is a front sectional view of a battery pack of a comparative example in which the whole of the sub-antenna 36 is shifted lower (Z−) from the position of the sub-antenna 36 in the present embodiment and is thus disposed lower (Z−) than the upper end 24z of the conductive connector 24. The transverse (X) and longitudinal (Y) position of the sub-antenna 36 in the comparative example is the same as in the present embodiment.

As in the comparative example, when the whole of the sub-antenna 36 is disposed lower (Z−) than the upper end 24z of the conductive connector 24, the direct wave Rd from the main antenna 46 is blocked by the conductive connector 24 and thereby does not reach the sub-antenna 36, and only the reflected wave Ri reaches the sub-antenna 36 and is thus received. Reversely, direct waves from the sub-antenna 36 is blocked by the conductive connector 24 and thereby does not reach the main antenna 46, and only the reflected wave reaches the main antenna 46 and is thus received.

In the present embodiment, however, the main antenna 46 and the sub-antenna 36 are, as illustrated in FIG. 4B, disposed in a region higher (Z+) than the upper end 24z of the conductive connector 24 in the housing despite the fact that the region is likely to be small due to the space problem or the like, In FIG. 4 and the like, an upper portion and like of the assembled batteries 20 are exaggeratingly illustrated for easy understanding. The actual region higher (Z+) than the upper end 24z of the conductive connector 24 in the housing 10 is much smaller than the region illustrated in FIG. 4 and the like.

The disposition of the antennas 46, 36 described above allows direct waves Rd from the main antenna 46 to reach the sub-antenna 36 without being blocked by any conductors including the conductive connector 24. Therefore, the sub-antenna 36 can receive from the main antenna 46 direct waves Rd having a higher propagation intensity than the propagation intensity of the reflected wave Ri. Reversely, direct waves from the sub-antenna 36 reaches the main antenna 46 without being blocked by any conductors including the conductive connector 24. Therefore, also the main antenna 46 can receive from the sub-antenna 36 direct waves having a higher propagation intensity than the propagation intensity of the reflected wave. The configuration described above enables the securement of communication reliability, in comparison with the cases in which each of the antennas 36, 46 can receive only the reflected wave from the other antenna 46, 36.

In the present embodiment, as illustrated in FIG. 3B, the upper gap, i.e., the first gap G1 is larger than the lower gap, i.e., the second gap G2. The sub-antenna 36 is disposed on the upper surface of the substrate 35. Therefore, it is possible to secure the space for disposing the sub-antenna 36 by effectively using the first gap (ii that is relatively larger between the first gap C31 and the second gap G2.

In the present embodiment, the housing 10 is a conductor such as a metal, the whole of the housing constitutes the shielding part that reflects radio waves. The main antenna 46 and the sub-antenna 36 are therefore surrounded by the shielding part. Therefore, external radio waves outside the housing 10 are less likely to reach the main antenna 46 and the sub-antenna 36. Therefore, radio wave interference is less likely to occur with the external radio waves. Therefore, this condition also enables reliable communication. Reversely, the radio waves emitted from the main antenna 46 and the sub-antenna 36 are less likely to be leaked to the exterior of the housing 10. Therefore, it is also possible to suppress adverse effects on other communication devices outside the battery pack 101.

In the present embodiment, the plurality of assembled batteries 20 are disposed in parallel in the transverse direction X. The projection 23 is a ridge extending in the longitudinal direction Y perpendicular to the transverse direction X. Therefore, the projection 23 extending in the longitudinal direction Y easily blocks direct waves between the main antenna 46 and the sub-antenna 36 under ordinary circumstances. In the present embodiment, the effects of allowing direct waves from each of the antennas 36, 46 to the other can be more prominently obtained.

In the present embodiment, the case 33 of each of the acquisition devices 30 is made from a non-conductor and therefore does not block radio waves. The sub-antenna 36 is disposed in the case 33, which is attached to the projection 23. This configuration enables the sub-antenna 36 to be easily disposed at a position at which the sub-antenna 36 can communicate via direct waves with the main antenna 46.

The lower portion of the case 33 is positioned between the: projections 23 and lower (Z−) than the upper end 24z of the conductive connector 24. Therefore, the space between the projections 23 can be effectively used.

### Second Embodiment

Next, a second embodiment is described. In the following embodiments, the members and the like identical or corresponding to those in the embodiment(s) mentioned before are assigned the identical symbol. The battery pack itself, however, is assigned a different symbol in each of the embodiments, The present embodiment is described on the basis of the first embodiment, focusing on features different from the features of the first embodiment.

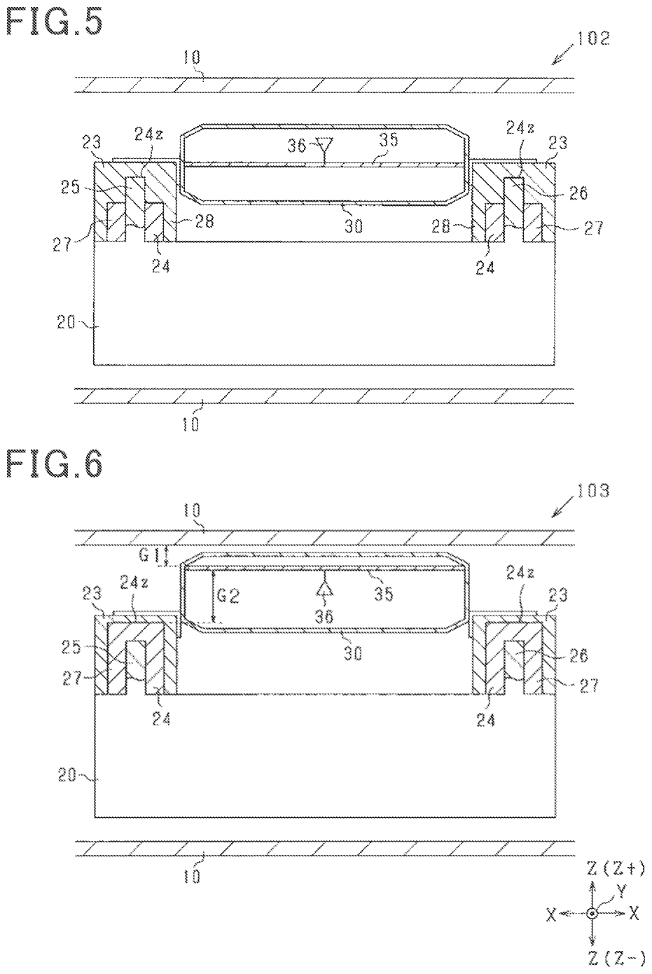

FIG. 5 is a front sectional view of a battery pack 102 according to the second embodiment. In the projection 23, the positive electrode terminal 25 and the negative electrode terminal 26 are disposed in such a form as to penetrate the bus bar 27 in the vertical direction Z. Therefore, in the present embodiment, upper ends of the positive electrode terminal 25 and the negative electrode terminal 26 constitute the upper end 24z of the conductive connector 24. The main antenna 46 and the sub-antenna 36 are disposed higher (Z+) than the upper end 24z of the conductive connector 24.

The present embodiment having an aspect in which the upper ends of the positive electrode terminal 25 and the negative electrode terminal 26 constitute the upper end 24z of the conductive connector 24 can also provide the same effects as those of the first embodiment.

### Third Embodiment

Next, a third embodiment is described. The present embodiment is described on the basis of the first embodiment, focusing on features different from the features of the first embodiment.

FIG. 6 is a front sectional view of a battery pack 103 according to the third embodiment. In the present embodiment, the substrate 35 is disposed higher (Z+) than in the first embodiment, and the lower gap, i.e., the second gap G2 is larger than the upper gap, i.e., the first gap G1. In each of the acquisition devices 30, the sub-antenna 36 is disposed on the lower surface of the substrate 35 in such a form as to project downward (Z−) from the lower surface.

In the present embodiment, the lower gap, i.e., the second gap G2 is larger than the upper gap, i.e., the first gap G1. The sub-antenna 36 is disposed on the lower surface of the substrate 35.

Therefore, it is possible to secure the space for disposing the sub-antenna 36 by effectively using the second gap (32 that is relatively larger between the first gap G1 and the second gap G2.

### Other Embodiments

The examples described above can be implemented with the following modifications. For example, in the drawings, the whole of each antenna 46, 36 is disposed higher (Id--) than the upper end of the projection 23. Instead of this configuration, at least a part of each antenna 46, 36 may be positioned lower (Z−) than the upper end of the projection 23 but higher (Z+) than the upper end 24z of the conductive connector 24. The antenna a part of which is even disposed lower (Z−) than the upper end of the projection 23 receives a radio wave as long as the part is higher (Z+) than the upper end 24z of the conductive connector 24. Therefore, this aspect enables effective use of a region (owe 2-) than the upper end of the projection 23 but higher (Z+) than the upper end 24z of the conductive connector 24.

For example, in the embodiments, the whole of each antenna 46, 36 is disposed higher (Z+) than the upper end 24z of the conductive connector 24, Instead of this configuration, a part of each antenna 46, 36 may be positioned lower (Z−) than the upper end 24z of the conductive connector 24 within the communicable range with direct waves between the antennas 46, 36. In other words, only a part of the antenna 46, 36 may be positioned higher (Z+) than the upper end 24Z of the conductive connector 24 so that each of the antennas 46, 36 can communicate with the other through direct waves.

For example, in the embodiments, at least a part (upper end) of the main antenna 46 is positioned higher than the upper end 24z of the conductive connector 24. Instead of this configuration, the upper end of the main antenna 46 may be positioned lower than the upper end 24z of the conductive connector 24 within the communicable range with direct waves between the main antenna 46 and the sub-antenna 36.

For example, in the embodiments, the substrate 35 of each of the acquisition devices 30 is disposed higher (Z+) than the upper end 24z of the conductive connector 24. instead of this configuration, the substrate 35 of each of the acquisition devices 30 may be disposed lower (Z−) than the upper end 24z of the conductive connector 24, and only an upper portion of the sub-antenna 36 may be positioned higher (Z+) than the upper end 24z of the conductive connector 24. This case also makes the first gap G1 larger than the second gap G2.

For example, in FIGS. 3 to 5, the sub-antenna 36 projects high upward from the upper surface of the substrate 35. Instead of this configuration, the sub-antenna 36 may project diagonally upward from the upper surface of the substrate 35. For example, in FIG. 6, the sub-antenna 36 projects right downward from the lower surface of the substrate 35. Instead of this configuration, the sub-antenna 36 may project diagonally downward from the lower surface of the substrate 35.

For example, in the drawings, the main antenna 46 projects right upward from the upper surface of the substrate 45. Instead of this configuration, the main antenna 46 may project diagonally upward from the upper surface of the substrate 45. For example, the substrate 45 of the monitor 40 may be disposed higher (Z+) than in the embodiments, and the main antenna 46 may project right downward or diagonally downward from the lower surface of the substrate 45.

For example, in the embodiments, the sub-antenna 36 is disposed in the case 33. Instead of this configuration, the sub-antenna 36 may be disposed on an outer surface of the case 33, an upper surface of the projection 23, or the like. For example, in the embodiments, the projection 23 is a ridge extending from the upper surface of the front-end battery cell 22 to the upper surface of the rear-end battery cell 22. Instead of this configuration, the projection 23 may be a ridge intermittently extending in the longitudinal direction Y, with interruption in every gap between bus bars 27.

For example, in the embodiments, the whole of the housing 10 is a conductor, but only a. part of the housing, such as an external surface thereof may be the shielding part made from a conductor. For example, in the embodiments, each of the assembled batteries 20 includes the plurality of battery cells 22 in a single line along the longitudinal direction Y, but may include the plurality of battery cells divided in t To or more lines. For example, in the present embodiments, the monitor 40 is disposed on the left-side surface of the left-end assembled battery 20, but may be disposed on a right-side surface of a right-end assembled battery 20, a front surface or a rear surface of a transversely middle assembled battery 20, an inner surface of the housing 10, or the like.

The present disclosure is described in accordance with the examples, but is to be understood not to be limited to the examples or the structures thereof. The present disclosure includes various modified examples and modifications within a range equivalent to the present disclosure. In addition, various combinations and aspects, other combinations and aspects including, in addition thereto, only one element or more or less are also encompassed in the scope or the idea of the present disclosure.

What is claimed is:

1. A battery pack comprising: a housing; a plurality of assembled batteries that are disposed in the housing and each of which includes a plurality of battery cells; respective acquisition devices configured to be disposed for each of the assembled batteries and that acquire from the assembled battery corresponding thereto battery information including voltage information of each of the battery cells; and a monitor configured to acquire the battery information through wireless communication with the respective acquisition devices,
the monitor including a main antenna for the wireless communication,
the respective acquisition devices including respective sub-antennas for the wireless communication, and
the respective assembled batteries including respective projections formed thereon, the respective projections including respective conductive connectors configured to electrically connect the battery cells to each other and be made from a conductor, wherein
when a direction in which the respective projections project is defined as a projection direction, the respective sub-antennas are disposed in the housing, at least a part of the respective sub-antennas being positioned farther in the projection direction than a projection-direction end of the respective conductive connectors is, and
a direct wave that is a radio wave emitted from the main antenna and is not reflected reaches the respective sub-antennas and is thus received without being blocked by the respective conductive connectors, and a direct wave that is a radio wave emitted from the respective sub-antenna and is not reflected reaches the main antenna and is thus received without being blocked by the respective conductive connectors.

2. The battery pack according to claim 1, wherein the respective conductive connectors each include an electrode terminal of each of the plurality of battery cells, and a bus bar configured to electrically connect electrode terminals of the battery cells adjacent to each other, and
the respective conductive connectors each have a first end in the projection direction, the first end being an end of the bus bar in the projection direction.

3. The battery pack according to claim 1, wherein
the respective conductive connectors each include an electrode terminal of each of the plurality of battery cells, and a bus bar configured to electrically connect electrode terminals of the battery cells adjacent to each other, and
the respective conductive connectors each have a first end in the projection direction, the first end being an end of the electrode terminal in the projection direction.

4. The battery pack according to claim 1, wherein
the respective acquisition devices each include a substrate extending in a direction intersecting the projection direction, and a gap in the projection direction between the substrate and an inner surface of the housing is larger than a gap in the projection direction between the first end and the substrate, and
the respective sub-antennas are each disposed on a projection-direction-side surface of the substrate.

5. The battery pack according to claim 1, wherein
the respective acquisition devices each include a substrate extending in a direction intersecting the projection direction, and a gap in the projection direction between the first end and the substrate is larger than a gap in the projection direction between the substrate and an inner surface of the housing, and
the respective sub-antennas are each disposed on a surface opposite to a projection-direction-side surface of the substrate.

6. The battery pack according to claim 1, wherein
the housing includes a shielding part made from a conductor, and
the shielding part surrounds the main antenna and the respective sub-antennas.

7. The battery pack according to claim 1, wherein
the plurality of assembled batteries are disposed in parallel in a first direction perpendicular to the projection direction, each of the assembled batteries includes the plurality of battery cells arranged in a second direction perpendicular to both the projection direction and the first direction, and the respective projections are each a ridge extending in the second direction.

8. The battery pack according to claim 1, wherein
the respective acquisition devices each include a case that is made from a non-conductor, the corresponding sub-antenna being disposed in the case and the case being attached to the corresponding projection.

9. The battery pack according to claim 8, wherein
a part of the case is positioned between a plurality of the projections and positioned in an opposite direction to the projection direction with respect to the projection-direction end of the corresponding conductive connector.

10. The battery pack according to claim 1, wherein
at least a part of the projections is positioned between the main antenna and the sub-antennas, and
the main antenna and the sub-antennas are arranged in a direction perpendicular to the projection direction,
